(19) United States
(12) Patent Application Publication
(10) Pub. No.: US 2006/0282374 A1
(43) Pub. Date: Dec. 14, 2006

(54) CREDIT UNDERWRITING BASED ELECTRONIC FUND TRANSFER

(75) Inventor: Brian Stone, Norcross, GA (US)

Correspondence Address: SMITH FROHWEIN TEMPEL GREENLEE BLAHA, LLC, P.O. BOX 88148, ATLANTA, GA, 30356, US

(73) Assignee: VALUED SERVICES INTELLECTUAL PROPERTY MANAGEMENT, INC. II., Las Vegas, NV (US)

(21) Appl. No.: 11/160,125

(22) Filed: Jun. 9, 2005

(51) Int. Cl. G06Q 40/00

(52) U.S. Cl. 705/38

(57) ABSTRACT

A credit underwriting technique that allows a consumer to gain early access to funds for paying bills or conducting financial transactions contingent upon the consumer having a high-degree of reliability on the reception of future funds, and/or the granting of access to at least a portion of the funds represented by the future funds when received. The access can be in the form of an electronic transfer from an account in which the funds are deposited, or a direct deposit of the funds into either a lender accessible account or into the lenders account directly. The access can be applied for aggregated financial transactions or can be periodically applied for recurring transactions.

### CROSS-REFERENCE TO RELATED APPLICATIONS

This application is related to U.S. patent application Ser. No. 10/645,949 filed on Aug. 22, 2003 and U.S. patent application Ser. No. 10/706,470 filed on Nov. 12, 2003, both of which are hereby incorporated by reference and is related to U.S. patent application having a title of CREDIT UNDERWRITING BASED ON PAPER INSTRUMENT, assigned Ser. No. ______ filed on ______.

### BACKGROUND OF THE INVENTION

Sooner or later, it just might happen to you. In our fast past society that brings us instant grits, instant coffee, and the microwave oven, one can easily find themselves upside down in the personal financial arena. You can imagine the frustration of just being a couple days away from being on top of things, but never quite being able to get totally right-side up. The financial market has attempted to come to the rescue for individuals that find themselves in situations such as described. However, the financial products currently available in the market to not address the needs of individuals that find themselves in this precarious situation—unable to qualify for traditional credit and just running a little bit behind on the bills.

Companies such as CompuCredit have developed financial products that are focused on providing financial relief to those individuals that find they are just running a little behind on their finances. Some of the CompuCredit products include: (a) a checkless checking account as described in U.S. patent application Ser. No. 10/645,949 filed on Aug. 22, 2003; and (b) a credit account to assist in debt recovery as described in U.S. patent application Ser. No. 10/706,470 filed on Nov. 12, 2003.

A need that exists in the art is the ability for an individual to obtain a loan in an expedited manner to help the individual pay his or her bills on time. For those individuals that do not meet the traditional qualifications for obtaining credit, there is a need in the art for the ability to obtain such a loan based on other qualifying elements. One such qualifying element can be the expected reception of a paycheck or other anticipated income, and/or the granting of access to those funds as collateral for the loan. Ideally, such a product would allow an individual to receive funds for the payment of bills or the satisfaction of other financial obligations just prior to actually having received his or her funds. Once the individual receives the funds, the loan can be paid off using those funds. Thus, the loan is underwritten based on the expected reception of future funding. For a credit underwriting that is based on an anticipated paycheck, the loan can be coined as a payday loan. There is a need in the market for such a product to allow a consumer to access a loan using a pending paycheck or the reception of other funds as collateral.

It will be appreciated that such a solution would require some level of assurance on the part of the financial institute that the funds for the repayment of the loan will be available and to gain some amount of leverage on the consumer to encourage the credit underwriting. Thus, there is a need in the art for a credit underwriting product that not only grants a loan to a consumer based on expected income or funding but also provides a level of assurance that the loan can be collected against the collateral.

### BRIEF SUMMARY OF THE INVENTION

The present invention is directed towards the provision of credit underwriting enabling customers to draw from an authorized loan amount that is provided based on the customer meeting particular criteria. The particular criteria may include one or more of the following non-limiting exemplary criteria: (1) a regular history of receiving a paycheck, (2) having an established financial account; (3) a promissory note or other form of expected future income or funds, and/or (4) granting access to the funds to the credit underwriter.

In one embodiment, the credit underwriting is contingent upon obtaining the authority to invoke an electronic transfer from an account associated with the customer. In this embodiment, a electronic transfer can be invoke in full or partial satisfaction of payments that were made on behalf of, or by the customer, using funds available through the credit underwriting. Thus, a single electronic transfer can be issued as a consolidation of the various payments that were made.

In another embodiment, the credit underwriting can be contingent upon obtaining approval to issue multiple electronic transfers from the customer's account. This embodiment is particularly suitable for handling recurring payments on behalf of the customer.

In various embodiments of the present invention, a customer applies for the credit underwriting and provides at least a subset of the afore-mentioned information, thereby meeting the requirements of the lending institution. Upon receiving the information, the lending institution grants approval of the credit underwriting if the minimum requirements are satisfied. For instance, in one embodiment, the customer's approval may be contingent upon the customer granting the lending institution access to the funds in a customer's account through the issuance of an electronic fund transfer from the account or other technique. Other techniques of granting access to the lending institution are also anticipated. In another embodiment, the approval of the loan may be contingent on the customer having a regular history of receiving a paycheck. In another embodiment, the approval may be contingent upon the customer having his or her paycheck directly deposited into a financial account that can be accessed by the lending institute. In yet another embodiment, the approval may be contingent upon the customer establishing evidence of an expected future reception of funds. Such funds may include, by way of a non-limiting example, the sale of an asset, alimony or child support payment, an inheritance, a court award, a settlement agreement, a promissory note, etc. Each of these items, once documented to the satisfaction of the lending institute, can serve as the basis for approving the credit underwriting. It should be appreciated that other forms or criteria may be applied in the approval process for the customer. For instance, the lending institute may conduct a credit history review of the customer. It should also be appreciated that although the various aspects of the present invention are described as multiple embodiments of the present invention, various combinations of the aspects can also be incorporated into other embodiments.

Once approved, the customer basically has a line of credit or an overdraft like protection. As the customer expends funds, this line of credit is drawn upon. At the expiration or termination of an established period of time or upon the occurrence of a particular event (i.e., customer receives a paycheck or other funds), the expended funds can be aggregated and paid by charging the aggregated amount against the line of credit. Alternatively, the funds are charged against the line of credit as they are incurred. In either case, upon the expiration of the loan term, the loan is either paid in full or in part by extracting funds from the customer's financial account.

The funds can be extracted from the customer's account in a variety of manners; however, an exemplary manner includes an electronic fund transfer from the customer's account. In one embodiment, the loan is paid off automatically in full once the customer's funds are deposited into the financial account. In another embodiment, the repayment of the loan is spread across multiple paychecks. In such an embodiment, a minimum payment may be required. Such a minimum payment may include any interest and fees charged for the period of time elapsed. In another embodiment, the loan may continue indefinitely as long as the customer satisfies a minimum payment requirement.

Thus, the various embodiments of the present invention enable a customer to obtain a credit underwriting approval for a loan against the expected reception of future funds, and then to have the loan paid off automatically once the customer receives the funds.

### BRIEF DESCRIPTION OF THE SEVERAL VIEWS OF THE DRAWING

FIG. 1 is a flow diagram illustrating the operation of the credit card based payday loan embodiment.

FIG. 2 is a block diagram illustrating the conceptual operation of the present invention.

### DETAILED DESCRIPTION OF THE INVENTION

The present invention is directed toward a credit underwriting of a loan that can give a consumer rapid access to funds using the future payment of expected funds as collateral and, provides a mechanism for the lending institute to have a level of assurance that the loan payoff can be collected. More specifically, aspects of the present invention can include (1) the approval of a consumer for a loan (2) basing the approval of the loan, at least in part, on the use of the consumer's future paycheck(s) or other expected funds as collateral for the loan (3) establishing a level of assurance that the financial or lending institute will be able to recoup the investment.

Advantageously, various embodiments of the present invention enable a consumer to gain access to funds through a loan instrument based on an expected reception of near-term funds, such as a paycheck. Such a loan can be used for a variety of purposes including the payment of bills that have come due prior to the reception of the consumer's paycheck, making a down payment on a house, making a mortgage payment, purchasing a product or service, facilitating the collection process for a credit card or any of a variety of other financial products. The loan or the credit underwriting can also be provided as an overdraft credit plan or extended to maintain a specified minimum balance in the consumer's account. In addition, the loan, or otherwise credit underwriting for the customer, can be used for the payment of recurring expenditures of the customer—such as a monthly bill, or can be applied to multiple financial transactions on behalf of the customer. Thus, the credit underwriting can be based on the approval to have multiple electronic transfers withdrawn from a customer's account in full or partial satisfaction of recurring payments, and/or can be contingent upon the approval of a single electronic transfer from the customer's account that provides full or partial satisfaction for consolidated payments or expenditures of the customer. Thus, the party providing the credit underwriting can periodically cause an electronic transfer to be invoked on behalf of the underwriting party in full or partial satisfaction of the loan. Being invoked on behalf of the underwriting party includes the transfer being performed in the name of the credit underwriting party or to some other party on behalf of the credit underwriting party.

The loan can be granted in a variety of manners. Non-limiting examples include through the use of a credit card, a debit card or a direct issue of funds into the consumer's account.

A consumer wishing to utilize the loan product must first sign-up for the product. To qualify for the product, the consumer may be required to meet minimum criteria. For instance, the minimum criteria may include that the consumer has an active checking account, the consumer has an active checking account with a minimum balance or minimum average balance, and proof of expected funds. The proof of expected funds may include a series of periodic check stubs, employment verification, a promissory note, a court order, a bill of sale etc.

### An Exemplary Embodiment—A Credit Card Based Product

The present invention can be embodied within a variety of environments. For illustrative purposes, a specific and non-limiting embodiment is described. This exemplary embodiment of the present invention is within a credit card and a credit card account environment. In the credit card embodiment, the loan process can be automatically invoked upon use of the card, it can be initiated prior to the issuance of the card, can be initiated when a certain amount of charges above a threshold amount are charged or can be granted along with approval for other financial products. In this embodiment, the loan is in the form of a credit limit being granted to the consumer. The credit limit is granted to the consumer contingent upon the financer or lender having access to upcoming and expected funds to be received by the consumer. For instance, to be approved for the financial product, the consumer may be required to give direct withdrawal access to the lender, such as through an electronic fund transfer, the issuance of a paper check, or other means.

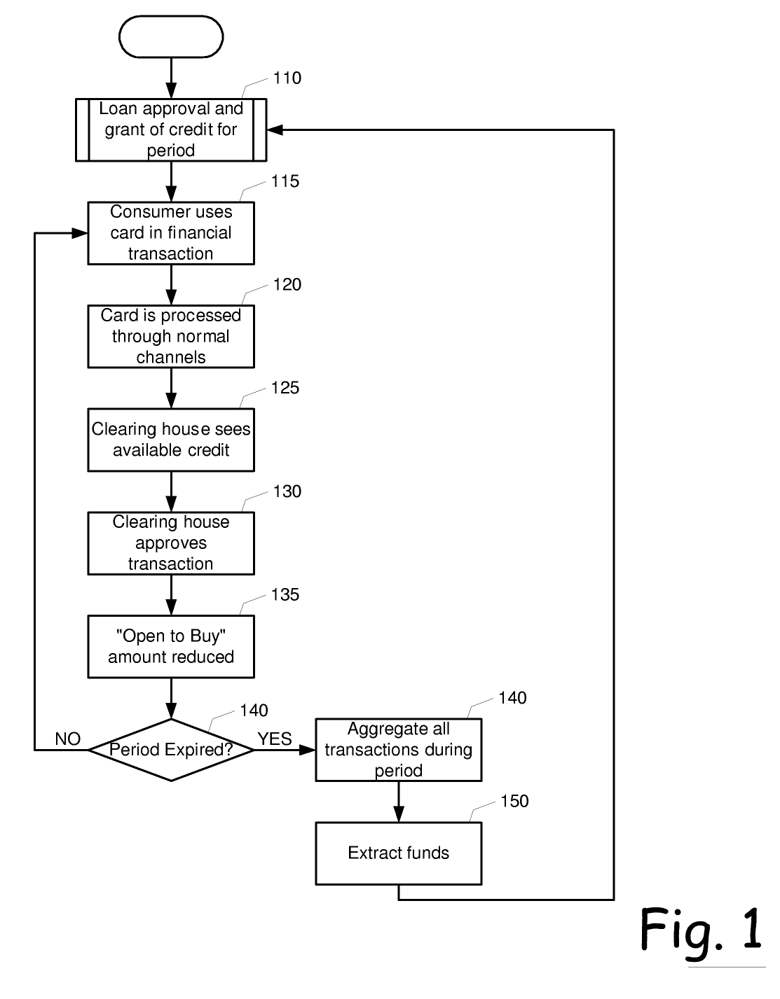

FIG. 1 is a flow diagram illustrating the operation of the credit card based credit underwriting embodiment for a loan. At step 110 the consumer is approved for credit underwriting. Once approved for credit underwriting, the consumer is granted access to a certain amount of funds for a period of time and/or the occurrence of a particular event (i.e., the reception of a paycheck or other sources of funds). The period of time is typically the amount of time allotted for the loan before the financial institute extracts funds from the consumers account for the repayment of the loan.

For example, suppose that the underwriting is based on the reception of a paycheck. A consumer requesting the credit underwriting normally gets paid on the last day of the month but he or she has a significant number of bills that are due on the 15th of the month. In this example, the period of the loan may be from the 15th of the month to the 3rd of the next month. In another embodiment, the term of the loan may expand multiple paycheck periods with a portion of the loan being extracted from the consumers account for each paycheck period. In yet another embodiment, a minimum amount may be required to be extracted from the consumers account during each paycheck cycle, such as the amount necessary to cover the fees and finance charges for the loan.

As another example, the underwriting can be based on a promissory note that the consumer possesses. In this example, the period of the loan is typically based on the maturity of the promissory note. For instance, the loan can be granted for a period of time extending 1 week beyond the maturity date for the promissory note.

During the sign-up or approval process, the consumer must complete minimal requirements to obtain approval. The minimum requirements typically include, as a non-limiting example, the proof of a periodic paycheck over a period of time, having an established checking account or savings account, having a direct deposit arrangement for either the checking or savings account and the granting of access to the financer to the checking or savings account for approval of an electronic transfer. Other embodiments may include additional requirements or may require fewer than these requirements. In particular, one embodiment may not require the establishment of a direct deposit arrangement.

At step 115 the consumer presents the credit card for a purchase or otherwise presents the card for a financial transaction. Again, the embodiment within a credit card is just one example of the present invention. The invention can be equally applied in other applications including, but not limited to, on-line bill payments, issuance of paper checks, electronic file transfers, pay-pal transactions, etc.

At step 120, the card is shown as being processed through normal channels (i.e., through the Visa network). At step 125, the clearing house sees the available credit that has been issued in association with the card. The clearing house then approves the transaction at step 130 and then reduces the credit or the open to buy limit accordingly 135.

If the period being applied for the loan has not expired 140, processing continues at step 115 for additional financial transactions. However, if the period has expired, payoff procedures are put into place. During the payoff procedures, all of the financial transactions occurring during the period are aggregated and a fee for the loan along with any applicable interest is then charged against the consumer 145. The funds are then automatically extracted from the consumers account for payment 150.

### An Exemplary Embodiment—A Debit Card Based Product

The present invention can also be embodied within a debit card environment. The operation of the debit card embodiment is similar to the credit card embodiment with the exception that rather than the loan taking the form of a credit on the card, the loan is activated similar to an overdraft protection mechanism. Thus, when the balance on the debit card account, or any account represented by the credit underwriting, drops below zero or a threshold amount, the payday loan kicks-in. At the end of a selected period of time, the accumulated deficit can be treated as a single aggregated debt and the loan can be applied in satisfaction of that debt.

Loan Payoff

As previously mentioned, the loan granted through the credit underwriting of the present invention is typically granted contingent upon the financer being able to gain access to the consumer's funds (i.e., their checking or savings account). Several embodiments are anticipated by the present invention; however, only two specific embodiments are described for exemplary purposes.

In one embodiment, the payoff of the loan is accomplished through a direct electronic fund transfer out of the consumers checking or savings account. In operation, the loan can be transferred into the consumers checking or savings account once approved (this is an alternate embodiment to the credit card or debit card based embodiments) and once the payoff threshold criteria has been met, the loan can be paid off in full or partially be automatically extracting the funds from the account along with any interest and associated fees. This embodiment obviously has the advantage of increasing the assurance of the loan being paid off. The direct electronic transfer of the payoff coupled with a requirement for the consumer's direct deposit of his or her paycheck even further increases this assurance.

However, it will be appreciated by those skilled in the art that in accordance with the Electronic Fund Transfer Act and NACHA regulations, a financial institute may not presently be allowed to make a credit card agreement or a credit arrangement contingent upon an automated electronic transfer of funds out of the consumer's account for the purposes of payment. In some embodiments, the operation of the present invention with a direct transfer of the loan payoff can be construed as violating these regulations.

In another embodiment, the loan payoff is accomplished through a paper check instrument. In this embodiment, once the loan is approved, the financer is granted the right to cause the issuance of a paper check out of the consumer's account. Thus, when the loan period expires, the financer is able to gain full or partial payment of the loan by causing a check to be issued on the consumer's account. In this embodiment, the loan or credit is made contingent upon the granting of the right to issue the paper check off of the consumer's account.

With the high-tech solutions and systems that have been incorporated into the financial services market, one can imagine how to implement a product to meet this need in the art through the use of electronic funding. For instance, if an individual qualifies for credit underwriting, a financial institution may want to protect itself by requiring the individual to grant the financial institution the right to electronically transfer funds from the individuals account after a certain period of time—the loan period. Typically the loan period would be long enough to allow the individual to receive and deposit the funds. Such an action would be performed through the individual's automatic clearing house “ACH” account.

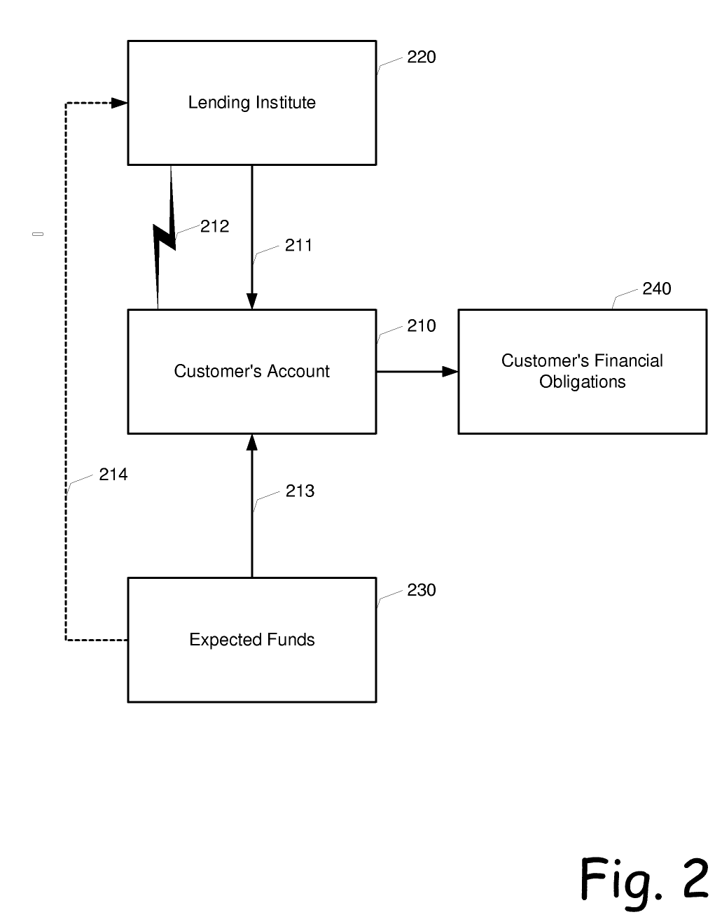

FIG. 2 is a block diagram illustrating the conceptual operation of the present invention. The credit underwriting can be contingent upon the financer or lending institute 220 gaining access to a customer's financial account 210. This access may include the ability to transfer funds into the customer's account 211 or to extract funds out of the customer's account through and electronic fund transfer 212. The credit underwriting may also be contingent up the consumer's expectation of receiving funds in the near future 230 and the gaining of access to these funds. In one embodiment, the expected funds 230 may be directly deposited into the consumer's financial account 210 (see 213), thereby giving access to the funds by the lending institute 220. In another embodiment, the funds may be directly transferred to the lending institute 220 (see 214) or to another party or entity on behalf of the lending institue. During the life of the loan based on the credit underwriting of the present invention, the consumer can apply the funds provided through the loan in satisfaction of certain financial obligations 240. Once the loan expires, the lending institute 220 can extract payment from the customer's account 210 to apply the expected funds 230 in satisfaction of the loan. Advantageously, the present invention, among other things, provides a financial product that enables a consumer to gain access to funds to satisfy financial obligations based on the expectation of future funds.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of skilled in the art. The scope of the invention is limited only by the following claims.

What is claimed is:

1. A credit underwriting method for approving a loan, the method comprising the steps of:
receiving a request from a customer;
obtaining access authorization of a financial account belonging to the requesting customer;
approving the requesting customer for credit underwriting based at least in part on obtaining access authorization to the requesting customer's financial account;
providing access to a loan to the requesting customer; and
extracting value from the financial account of the requesting customer in at least partial satisfaction of the loan by causing an electronic transfer from the customer's financial account on behalf of the party providing the credit underwriting.

2. The method of claim 1, wherein the step of providing access to the loan comprises aggregating multiple financial transactions by the requesting customer and applying the funds in the loan to satisfy the aggregated financial transactions.

3. The method of claim 1, wherein the loan is a credit that is applied to a credit card like instrument and the financial transactions conducted against that credit are the financial transactions satisfied by the loan.

4. The method of claim 1, wherein the loan operates as an overdraft protection for a debit card.

5. The method of claim 1, further comprising the step of reviewing the paycheck history of the requesting customer and the step of approving the requesting customer for credit underwriting is based at least in part on the paycheck history.

6. The method of claim 5, wherein the loan is a credit that is applied to a credit card like instrument and the financial transactions conducted against that credit are the financial transactions satisfied by the loan.

7. The method of claim 5, wherein the loan operates as an overdraft protection for a debit card.

8. The method of claim 1, further comprising the step of reviewing the credit history of the requesting customer and the step of approving the requesting customer for credit underwriting is based at least in part on the credit history.

9. The method of claim 1, wherein the step of approving the requesting customer for credit underwriting based at least in part on obtaining access authorization to the requesting customer's financial account results in a contingency that is based on authorization to perform an electronic transfer.

10. The method of claim 9, wherein the loan is an overdraft credit plan.

11. The method of claim 9, wherein the loan is extended to maintain a specified minimum balance in the consumer's financial account.

12. A credit underwriting process for providing a temporary loan tied to the expected reception of future funds, the process comprising:
approving a loan that is based upon a requesting customer:
granting access authorization to a financial account belonging to the requesting customer; and
demonstrating a probability for the reception of future funds;
establishing a time period over which the loan will remain in effect;
applying the loan amount towards the satisfaction of financial transactions of the requesting customer; and
extraction of value related to the applied loan amount from the financial account of the requesting customer by invoking an electronic transfer of at least a portion of the future funds once they are received.

13. The credit underwriting process of claim 12, wherein the step of applying the loan amount towards the satisfaction of financial transactions further comprises applying the loan amount towards recurring financial obligations.

14. The credit underwriting process of claim 12, wherein the step of applying the loan amount towards the satisfaction of financial transactions further comprises applying the loan amount towards multiple financial obligations.

15. The credit underwriting process of claim 12, wherein the loan approval is contingent on the requesting customer agreeing to allow an electronic fund transfer.

16. The credit underwriting process of claim 12, wherein the loan approval is contingent on the requesting customer agreeing to allow an electronic fund transfer directly to the party providing the credit underwriting.

17. The credit underwriting process of claim 12, wherein demonstrating a probability for the reception of future funds comprises establishing a history of paycheck receptions.

18. A method for providing credit underwriting, the method comprising the steps of:
receiving a request for credit underwriting from a customer;
obtaining access authorization of a financial account belonging to the requesting customer;
approving the requesting customer for the credit underwriting based at least in part on obtaining access authorization to the financial account;
providing funds in satisfaction of financial transactions identified by the requesting customer; and
extracting value from the financial account of the requesting customer in at least partial satisfaction of the provided funds by performing an electronic fund transfer out of the requesting customer's financial account.

19. The method of claim 18, wherein the step of providing funds comprises aggregating multiple financial transactions to be satisfied.

20. The method of claim 18, wherein the credit underwriting is for a credit that is applied to a credit card like instrument and the financial transactions conducted against that credit are the financial transactions satisfied by provided funds.

21. The method of claim 18, wherein the credit underwriting operates as an overdraft protection for a debit card.

22. The method of claim 18, further comprising the step of reviewing the paycheck history of the requesting customer and the step of approving the requesting customer for underwriting is based at least in part on the paycheck history.
